(19) United States
(12) Patent Application Publication
(10) Pub. No.: US 2025/0268280 A1
(43) Pub. Date: Aug. 28, 2025

(54) COMPOSITIONS AND METHODS FOR DEHYDRATED PET FOOD BLENDS

(71) Applicant: Société des Produits Nestlé S.A., vevey (CH)

(72) Inventors: Sebastien COUEDEL, Rainneville (FR); Daniel Erickson, Plymouth, MN (US); Magali MILLEROT, AUBIGNY (FR); Claude LECOUTEUX, ST LOUIS, MO (US); Thierry Xavier Lavallard, DEMUIN (FR); Stéphane TRAVERT, Longueau (FR)

(73) Assignee: Société des Produits Nestlé S.A., vevey (CH)

(21) Appl. No.: 18/857,161

(22) PCT Filed: May 3, 2023
(86) PCT No.: PCT/IB2023/054613

§ 371 Date: Oct. 15, 2024

(30) Foreign Application Priority Data
May 25, 2022 (FR) 2205076

(51) Int. Cl. A23K 20/147; A23K 10/20; A23K 10/30; A23K 20/158; A23K 20/163; A23K 20/174; A23K 30/20; A23K 40/10; A23K 40/25; A23K 50/45

(52) U.S. Cl. CPC A23K 20/147; A23K 10/20; A23K 10/30; A23K 20/158; A23K 20/163; A23K 20/174; A23K 30/20; A23K 40/10; A23K 40/25; A23K 50/45

(57) ABSTRACT

The present invention provides compositions and methods directed to a dehydrated pet food blend. The dehydrated pet food blend can comprise about 15% to about 50% protein. about 5% to about 40% fat, and about 5% to about 50% carbohydrate. Additionally, the blend can comprise semi-moist kibbles, dried meal, and dehydrated vegetables.

### CROSS REFERENCE TO RELATED APPLICATIONS

This application claims priority to French utility certificate application No. 205076 filed May 25, 2022, the disclosure of which is incorporated in its entirety herein by this reference.

### BACKGROUND OF THE INVENTION

### Description of Related Art

Dry pet food comprising kibble coated with a dry natural gravy coating that reconstitutes when mixed with water is well known. Canned dog food containing meat chunks and vegetables is also well known. Additionally, dry pet foods have been introduced that comprise freeze-dried vegetables. Advantages for using dehydrated food components include increased stability, perception of healthier eating, can minimize preservatives, and reduction of transportation costs but can increase production times, production costs, and have low acceptance.

As such, research and development efforts continue in the area of dried and dehydrated food compositions to develop more effective compositions.

### SUMMARY OF THE INVENTION

It is, therefore, an object of the present invention to provide compositions and methods directed to dehydrated pet food blends.

In one embodiment, a dehydrated pet food blend can comprise about 15% to about 50% protein, about 5% to about 40% fat, and about 5% to about 50% carbohydrate. Additionally, the blend can comprise semi-moist kibbles, dried meal, and dehydrated vegetables.

Additionally, in another embodiment, a method for manufacturing a dehydrated pet food blend can comprise extruding a semi-moist kibble, extruding a dried kibble, grinding the dried kibble to form a dried meal, and admixing the semi-moist kibble and the dried meal with dehydrated vegetables to form the dehydrated pet food blend.

Other and further objects, features, and advantages of the present invention will be readily apparent to those skilled in the art.

### DETAILED DESCRIPTION OF THE INVENTION

### Definitions

The term “companion animal” means any domesticated animal, and includes, without limitation, cats, dogs, rabbits, guinea pigs, ferrets, hamsters, mice, gerbils, horses, cows, goats, sheep, donkeys, pigs, and the like. In one specific aspect, the animal or companion animal can be a dog or cat.

The term “food” or “food product” or “food composition” means a product or composition that is intended for ingestion by an animal and provides nutrition to the animal.

The term “pet food” or “pet food composition” means a composition intended for consumption by companion animals.

The term “complete and balanced” or “nutritionally balanced” when referring to a food composition means a food composition that contains all known required nutrients in appropriate amounts and proportions based on recommendations of recognized authorities in the field of animal nutrition and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO). The term includes any food, feed, snack, food supplement, treat, meal substitute, or meal replacement, whether intended for a human or another animal. Animal food includes food or feed intended for any domesticated or wild species. In some embodiments, a food for an animal represents a complete and balanced food composition, e.g., a pelleted, extruded, or dry food. Examples of such animal foods include extruded pet foods, such as foods for dogs and cats.

The term “long-term administration” means periods of repeated administration or consumption in excess of one month. Periods of longer than two, three, or four months can be used for certain embodiments. Also, extended periods can be used that include longer than 5, 6, 7, 8, 9, or 10 months. Periods in excess of 11 months or 1 year can also be used. Longer term use extending over 1, 2, 3, or more years can also be used. For certain aging animals, the animal can continue consuming on a regular basis for the remainder of its life. Sometimes this can be referred to as consumption for “extended” periods.

The term “regular basis” means at least monthly dosing with the compositions or consumption of the compositions, and in one aspect, weekly dosing. More frequent dosing or consumption, such as twice or three times weekly, can also be performed in certain embodiments. Still, in other aspects, regimens that comprise at least once daily consumption can be employed. The skilled artisan will appreciate that the blood level of a compound or certain metabolites of that compound or which result after the consumption of that compound, may be a useful tool for assessing or determining dosing frequency. For example, for determining dosage or dosage frequency for compositions comprising MCTs, the blood concentration of ketone bodies, or a specific ketone body may provide useful information. A frequency, regardless of whether expressly exemplified herein, that allows maintenance of a desired blood level of the measured compound within acceptable ranges is useful herein. The skilled artisan will appreciate that dosing frequency will be a function of the composition that is being consumed or administered, and some compositions may require more or less frequent administration to maintain a desired blood level of the measured compound (e.g., a ketone body).

The term “oral administration” or “orally administering” means that the animal ingests, or a human is directed to feed, or does feed, the animal one or more of the compositions described herein. Wherein a human is directed to feed the composition, such direction may be that which instructs and/or informs the human that use of the composition may and/or will provide the referenced benefit, for example, increasing mobility or activity, or preventing, reducing, or delaying a decline in such foregoing functions or qualities. Such direction may be oral direction (e.g., through oral instruction from, for example, a physician, veterinarian, or other health professional, or radio or television media (i.e., advertisement), or written direction (e.g., through written direction from, for example, a physician, veterinarian, or other health professional (e.g., prescriptions), sales professional or organization (e.g., through, for example, marketing brochures, pamphlets, or other instructive paraphernalia), written media (e.g., internet, electronic mail, website, or other computer-related media), and/or packaging associated with the composition (e.g., a label present on a container holding the composition), or a combination thereof (e.g., label or package insert with directions to access a website for more information).

The term “individual” when referring to an animal means an individual animal of any species or kind.

The term “microorganism” encompasses at least bacteria, molds and other fungi, and yeasts. Probiotics are beneficial microorganisms that can survive or even multiply and thrive in the gastrointestinal tract of an animal. Probiotics can contribute to the overall health of an animal generally and particularly to the gastrointestinal health of the animal.

The term “single package” means that the components of a kit are physically associated, in or with one or more containers, and considered a unit for manufacture, distribution, sale, or use. Containers include, but are not limited to, bags, boxes or cartons, bottles, packages of any type or design or material, over-wrap, shrink-wrap, affixed components (e.g., stapled, adhered, or the like), or combinations of any of the foregoing. For example, a single package kit may provide containers of individual compositions and/or food compositions physically associated such that they are considered a unit for manufacture, distribution, sale, or use.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, view a visual message, or contact a caregiver or instructor to obtain, for example, instructions on how to use the kit, or safety or technical information about one or more components of a kit. Examples of information that can be provided as part of a virtual kit include instructions for use; safety information such as material safety data sheets; poison control information; information on potential adverse reactions; clinical study results; dietary information such as food composition or caloric composition; general information on behavioral or motor function; diseases that effect behavioral or motor function; treating behavioral or motor function; or general information on treatment or preservation of behavioral or motor function; self-help relating to behavioral or motor function; caregiver information for those caring for animals with behavioral or motor function challenges; and use, benefits, and potential side-effects or counter-indications for the compositions or drugs.

All percentages expressed herein are by weight of the composition on a dry matter basis unless specifically stated otherwise. The skilled artisan will appreciate that the term “dry matter basis” means that an ingredient's concentration or percentage in a composition is measured or determined after any free moisture in the composition has been removed.

As used throughout, ranges are used herein in shorthand, so as to avoid having to set out at length and describe each and every value within the range. Any appropriate value within the range can be selected, where appropriate, as the upper value, lower value, or the terminus of the range.

The term “about” means plus or minus 20%: in one aspect, plus or minus 10%; in another aspect, plus or minus 5%; and in one specific aspect, plus or minus 2%.

As used herein and in the appended claims, the singular form of a word includes the plural, and vice versa, unless the context clearly dictates otherwise. Thus, the references “a”, “an”, and “the” are generally inclusive of the plurals of the respective terms. For example, reference to “a method” or “a food” includes a plurality of such “methods” or “foods”. Reference herein, for example to “an antioxidant” includes a plurality of such antioxidants, whereas reference to “pieces” includes a single piece. Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. Where used herein the term “examples,” particularly when followed by a listing of terms is merely exemplary and illustrative and should not be deemed to be exclusive or comprehensive.

As used herein, embodiments, aspects, and examples using “comprising” language or other open-ended language can be substituted with “consisting essentially of” and “consisting of” embodiments.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the certain compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved. Full citations for publications not cited fully within the specification are set forth at the end of the specification.

### The Invention

In one embodiment, a dehydrated pet food blend can comprise about 15% to about 50% protein, about 5% to about 40% fat, and about 5% to about 50% carbohydrate. Additionally, the blend can comprise semi-moist kibbles, dried meal, and dehydrated vegetables.

Additionally, in another embodiment, a method for manufacturing a dehydrated pet food blend can comprise extruding a semi-moist kibble, extruding a dried kibble, grinding the dried kibble to form a dried meal, and admixing the semi-moist kibble and the dried meal with dehydrated vegetables to form the dehydrated pet food blend.

In one embodiment, the extruded dried kibble can include drying the extruded dried kibble to remove moisture from the dried kibble. As such, in one aspect, the dried kibble can be extruded with normal moisture and subsequently dried to form the dried kibble. In one aspect. the dried meal can be first admixed with the dehydrated vegetables to form a dried blend, and then the dried blend is admixed with the semi-moist kibbles to form the dehydrated pet food blend.

Additionally, a method of administering a dehydrated pet food blend to an animal can comprise admixing the dehydrated pet food blend with water to rehydrate the dried and dehydrated components of the blend and then administering the composition to the companion animal.

Generally, the dehydrated pet food blend can comprise semi-moist kibbles. The semi-moist kibbles can have a moisture content from about 10% to about 30% by weight. In one aspect, the moisture content can be from about 10% to about 20% by weight. In one embodiment, the semi-moist kibbles can be present in the blend in an amount from about 10% to about 50% by weight. In one aspect, the semi-moist kibbles can be in the blend in an amount from about 20% to about 30%.

Generally, the dehydrated pet food blend can comprise dried meal. The dried meal can have a moisture content from about 5% to about 12% by weight. In one aspect, the moisture content can be from about 6% to about 8% by weight. In one embodiment, the dried meal can be present in the blend in an amount from about 40% to about 90% by weight. In one aspect, the dried meal can be in the blend in an amount from about 60% to about 70%.

Generally, the dehydrated pet food blend can comprise dehydrated vegetables. The dehydrated vegetables can have a moisture content from about 1% to about 10% by weight. In one aspect, the moisture content can be from about 5% to about 8% by weight. In one embodiment, the dehydrated vegetables can be present in the blend in an amount from about 5% to about 30% by weight. In one aspect, the dehydrated vegetables can be in the blend in an amount from about 5% to about 10%.

In one aspect, the methods and compositions can include one or more B vitamins, one or more antioxidants, or combinations thereof. The B vitamins can be any B vitamin suitable for administration to an animal. B vitamins include vitamins B1 (thiamine), B2 (riboflavin), B3 (aka P or PP) (niacin, including nicotinic acid and/or nicotinamide), B5 (pantothenic acid), B6 (pyridoxine), B7 (aka H) (biotin), B8 (myo-inositol), B9 (aka M or B-c) (folic acid), B12 (cobalamin), or salts, conjugates, or derivatives thereof recognized of found to have B vitamin activity. Combinations of any of the foregoing can also be useful herein and are sometimes referred to herein as “mixtures” of B vitamins. Since the vitamin requirements vary for different species, not all of the listed compounds are deemed vitamins for all species. For example, since it is known that myo-inositol can be synthesized by humans, it is no longer deemed a vitamin, as it is not required for adequate human nutrition. The antioxidants can be any antioxidant suitable for administration to an animal. Antioxidants are well known in the art, particularly the art of food technology and food formulation. Natural antioxidant compounds include vitamins (such as A, C and E, and derivative, conjugates, or analogs thereof), as well as plant extracts, including extracts from fruit, vegetables, herbs, seeds, and other types and/or parts of plants. Compounds such as α-lipoic acid, chlorophyll and derivatives thereof, glutathione, ubiquinols (e.g., coenzyme Q10), carotenoids (e.g., lycopene), flavonoids, phenolic acids and polyphenols, and pycnogenol are known to be excellent antioxidants. Some examples of plant sources of antioxidants include those from fruits such as berries (cherry, blackberry, strawberry, raspberry, crowberry, blueberry, bilberry/wild blueberry, black currant), pomegranate, grape, orange, plum, pineapple, kiwi fruit, and grapefruit: those from vegetables including kale, chili pepper, red cabbage, peppers, parsley, artichoke, Brussels sprouts, spinach, lemon, ginger, garlic, and red beets: those from dry fruits like apricots, prunes, and dates: from legumes including broad beans, pinto beans, and soybeans. Also nuts and seeds such as pecans, walnuts, hazelnuts, ground nut, and sunflower seeds: cereals such as barley, millet, oats, and corn. Many natural antioxidants are also available from a wide variety of spices including cloves, cinnamon, rosemary, and oregano. Less widely known sources of antioxidants include Ginkgo biloba, and tropical plants such as uyaku, and carica papaya. Antioxidant properties of various teas and green teas, as well as fermented products such as red wine, have become of great interest in recent years and such would be suitable for use herein. Selenium is an excellent oxygen scavenger and works well, especially with vitamin or related tocopherol compounds. Synthetic dietary antioxidants include butylated hydroxyanisole (BHA) and butylated hydroxytoluene (BHT) which are commonly used in food products. Any of the foregoing, alone or in combination, can be suited for use herein, as can be combinations of natural and synthetic antioxidants

Additionally, the B vitamins and antioxidants can be present in any acceptable amount including recommended daily amounts. In one embodiment, the composition comprises from about 0.1 to 40 times the recommended daily requirement (RDA) of B vitamins and from about 0.01 to 25 times the RDA of antioxidants. In various embodiments, the B vitamins comprise from about 4 to 20 times the RDA, and in one aspect, from about 1 to 10 times the RDA, and antioxidants comprise from about 0.01 to 15 times the RDA, and in one aspect, from about 0.01 to 5 times the RDA, or even from about 0.01 to 2 times the RDA.

The compositions may further comprise substances such as minerals, other vitamins, salts, functional additives including, for example, palatants, colorants, emulsifiers, antimicrobial or other preservatives. Minerals that may be useful in such compositions include, for example, calcium, phosphorous, potassium, sodium, iron, chloride, boron, copper, zinc, magnesium, manganese, iodine, selenium, and the like. Examples of additional vitamins useful herein include such fat-soluble vitamins as A, D, E, and K. Inulin, amino acids, enzymes, coenzymes, and the like may be useful to include in various embodiments. The present compositions can include from about 0.01% to about 2.0% of such components.

The present compositions include foods intended to supply the necessary dietary requirements for an animal, animal treats (e.g., biscuits), or dietary supplements.

The compositions can optionally comprise one or more supplementary substances that promote or sustain general health. Such substances may be associated with improved mental health or enhanced cognitive function or may be substances that inhibit, delay, or decrease loss of cognitive function, e.g., herbs or plants that enhance cognitive function.

In various embodiments, pet food or pet treat compositions comprise from about 15% to about 50% crude protein. The crude protein material may comprise vegetable proteins such as soybean meal, soy protein concentrate, corn gluten meal, wheat gluten, cottonseed, and peanut meal, or animal proteins such as casein, albumin, and meat protein. Examples of meat protein useful herein include pork, lamb, equine, poultry, fish, and mixtures thereof.

The compositions may further comprise from about 5% to about 40% fat. The compositions may further comprise a source of carbohydrate. The compositions may comprise from about 5% to about 50% carbohydrate. Examples of such carbohydrates include grains or cereals such as rice, corn, milo, sorghum, alfalfa, barley, soybeans, canola, oats, wheat, and mixtures thereof. The compositions may also optionally comprise other materials such as dried whey and other dairy by-products.

In some embodiments, the ash content of the composition ranges from less than 1% to about 15%, and in one aspect, from about 5% to about 10%.

The moisture content of the dehydrated pet food blend can be from about 5% to about 12% by weight. In one aspect, the moisture content can be from about 5% to about 10%. In one embodiment, the composition can be a complete and nutritionally balanced pet food.

The compositions may also comprise one or more fiber sources. The term “fiber” includes all sources of “bulk” in the food whether digestible or indigestible, soluble or insoluble, fermentable or nonfermentable. Fibers include plant sources such as marine plants, but microbial sources of fiber may also be used. A variety of soluble or insoluble fibers may be utilized, as will be known to those of ordinary skill in the art. The fiber source can be beet pulp (from sugar beet), gum arabic, gum talha, psyllium, rice bran, carob bean gum, citrus pulp, pectin, fructooligosaccharide, short chain oligofructose, mannanoligofructose, soy fiber, arabinogalactan, galactooligosaccharide, arabinoxylan, or mixtures thereof.

Alternatively, the fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may also be incorporated into the composition to aid in the enhancement of the benefit provided by the present invention to the immune system of an animal.

In other embodiments, the compositions further comprise prebiotics or probiotics. Probiotics are live microorganisms that have a beneficial effect in the prevention and treatment of specific medical conditions when ingested. Probiotics are believed to exert biological effects through a phenomenon known as colonization resistance. The probiotics facilitate a process whereby the indigenous anaerobic flora limits the concentration of potentially harmful (mostly aerobic) bacteria in the digestive tract. Other modes of action, such as supplying enzymes or influencing enzyme activity in the gastrointestinal tract, may also account for some of the other functions that have been attributed to probiotics. Prebiotics are nondigestible food ingredients that beneficially affect host health by selectively stimulating the growth and/or activity of bacteria in the colon. Prebiotics include fructooligosaccharides (FOS), xylooligosaccharides (XOS), galactooligosaccharides (GOS), and mannooligosaccharides (typically for non-human foods such as petfoods). The prebiotic, fructooligosaccharide (FOS) is found naturally in many foods such as wheat, onions, bananas, honey, garlic, and leeks. FOS can also be isolated from chicory root or synthesized enzymatically from sucrose. FOS fermentation in the colon results in a large number of physiologic effects including increasing the numbers of bifidobacteria in the colon, increasing calcium absorption, increasing fecal weight, shortening of gastrointestinal transit time, and possibly lowering blood lipid levels. The increase in bifidobacteria has been assumed to benefit human health by producing compounds to inhibit potential pathogens, by reducing blood ammonia levels, and by producing vitamins and digestive enzymes. Probiotic bacteria such as Lactobacilli or Bifidobacteria are believed to positively affect the immune response by improving the intestinal microbial balance leading to enhanced antibody production and phagocytic (devouring or killing) activity of white blood cells. Bifidobacterium lactis could be an effective probiotic dietary supplement for enhancing some aspects of cellular immunity in the elderly. Probiotics enhance systemic cellular immune responses and may be useful as a dietary supplement to boost natural immunity in otherwise healthy adult companion animals. Probiotics include many types of bacteria but generally are selected from four genera of bacteria: Lactobacillus acidophillus, Bifidobacteria, Lactococcus, and Pediococcus. Beneficial species include Enterococcus and Saccharomyces species. The amount of probiotics and prebiotics to be administered to the animal can be determined by the skilled artisan based upon the type and nature of the prebiotic and probiotic and the type and nature of the animal, e.g., the age, weight, general health, sex, extent of microbial depletion, presence of harmful bacteria, and diet of the animal. Generally, probiotics can be administered to the animal in amounts of from about one to about twenty billion colony forming units (CFUs) per day for the healthy maintenance of intestinal microflora, in one aspect, from about 5 billion to about 10 billion live bacteria per day. Generally, prebiotics can be administered in amounts sufficient to positively stimulate the healthy microflora in the gut and cause these “good” bacteria to reproduce. Typical amounts can be from about one to about 10 grams per serving or from about 5% to about 40% of the recommended daily dietary fiber for an animal. The probiotics and prebiotics can be made part of the composition by any suitable means. Generally, the agents can be mixed with the composition or applied to the surface of the composition, e.g., by sprinkling or spraying. When the agents are part of a kit, the agents can be admixed with other materials or in their own package.

The compositions and dietary supplements may be specially formulated for the intended recipients or consumers, such as for adult animals or for older or young animals. For example, a composition adapted for puppies or kittens or adapted for active, pregnant, lactating, or aging animals can be prepared. In general, specialized compositions will comprise energy and nutritional requirements appropriate for animals at different stages of development or age.

Certain aspects of the invention can be used in combination with a complete and balanced food. According to certain embodiments provided herein, the compositions can be used with a high-quality commercial food. As used herein, “high-quality commercial food” refers to a diet manufactured to produce the digestibility of the key nutrients of 80% or more, as set forth in, for example, the recommendations of the National Research Council above for dogs, or in the guidelines set forth by the Association of American Feed Control Officials. Similar high nutrient standards would be used for other animals.

In one embodiment, the food compositions comprise any of a variety of ingredients or combinations thereof selected for their contributions to the overall composition. Thus, a skilled food technologist may choose from among natural (e.g., plant or plant-derived, animal or animal-derived, and microbial or microbially-derived), and synthetic ingredients or components. In particular embodiments, the ingredients may include any of the cereal grains and/or fractions or components thereof, meat and meat by-products, fish, shellfish, or other seafood, other animal products or by-products, eggs from any source, vitamins, minerals, salts, sweeteners, fiber, flavoring or other palatants, coloring, and functional ingredients such as emulsifiers, stabilizers, softeners, functional coatings, and the like. In one aspect, the kibbles can be coated with an animal digest coating, which can optionally contain a fat. Cereals useful in the invention include all plants recognized as “cereal” crops, whether currently used in commercial agriculture or merely known practically or botanically as being a “cereal”. For example, “cereals” includes corn, wheat, rice, barley, sorghum, millet, oats, rye, triticale, buckwheat, fonio, and quinoa. The skilled artisan will appreciate that in each food composition, the use of one or more such cereal products can be common. Meats useful in the invention include products from any animal, including muscle tissue such as chicken or other poultry, lamb, sheep, veal, beef, or pork. Other animal products and by-products useful in the invention include dairy products or by-products derived from the milk of any species. Other important components or ingredients include fats, and the skilled artisan will appreciate that many sources of vegetable, animal, or microbial fats are available for formulating food compositions. In one embodiment, the source of fat can be a plant fat such as corn, soy, or canola oil, including those that are readily available. In another embodiment, an animal fat, such as tallow, can be useful for providing calories from fat, as well as enticing flavor to meat-eating animals. Of course, combinations of any of the foregoing ingredients, such as fats, are known in the art and useful for optimizing the food compositions based on functional properties as well as price and availability.

The skilled artisan will also appreciate that in formulating the food compositions of the invention, the formulation may vary slightly, to allow consideration by the formulator of the price and/or availability of certain ingredients in the compositions, as well as the batch-to-batch variation in the analysis of certain ingredients. Thus, a given food composition or formulation may vary slightly from batch to batch, plant to plant, or even season to season depending on such factors. Notwithstanding such variation in specific ingredients selected for manufacturing a particular batch of a food composition, the overall composition (for example, analysis of protein, carbohydrate, fat, fiber, or other component) may be held constant or at least substantially constant, for example, in accordance with a label claim, such as a claim or guarantee of a minimum or maximum percent of a particular component.

In one embodiment, the food compositions comprise a macronutrient composition suitable for the type of food being designed. In one embodiment, the food composition can have about 20 to 32% protein, about 30 to 50% carbohydrate, about 5% to 20% fat, and about 5% to 12% moisture. In another embodiment, the food composition can be a pet food composition such as a premium or super-premium pet food composition. In one embodiment, the pet food can be formulated for canines and has a protein content of about 20-30%, in one aspect, about 24-28%, or even about 25-27%. In one embodiment, the protein content of a dog food composition can be about 26% by weight. In another embodiment, the formulation can be for felines and can have a protein content of about 35-45%, in one aspect, about 37-42%, or even about 39-41%. In one embodiment, the protein content of a cat food composition can be about 40%.

Additionally, in one embodiment, a method of administering a dehydrated pet food blend to an animal can comprise admixing water with the dehydrated pet food blend to form a rehydrated pet food blend and feeding the rehydrated pet food blend to the animal. Rehydrating can be accomplished by adding water in an amount sufficient to replace the water that has been removed during dehydration/drying processes. In one embodiment, the amount of water added can be from about 0.1 ml to about 10 ml per 1 gram of dehydrated pet food blend, although amounts more or less than this range can also be used. In one aspect, the amount of water can be from about 0.8 ml to about 1 ml per 1 gram of dehydrated pet food blend. Administration in accordance with the methods can be on an as-needed or as-desired basis of varying or regular frequency. A goal of regular ingestion is to provide the animal with a regular and consistent dose of the composition or the direct or indirect metabolites that result from such ingestion. Such regular and consistent dosing will tend to create constant blood levels of the components of the compositions or their direct or indirect metabolites. Thus, regular administration can be once monthly, once weekly, once daily, or more than once daily. Similarly, administration can be every other day, week, or month, every third day, week, or month, every fourth day, week, or month, and the like. Administration can be multiple times per day. When utilized as a supplement to ordinary dietetic requirements, the composition may be administered directly to the animal, e.g., orally, or otherwise. Generally, the dehydrated food blend can be admixed with water prior to feeding the animal. The compositions can alternatively be contacted with, or admixed with, daily feed or food, including a fluid, such as drinking water, or an intravenous connection for an animal that is receiving such treatment. When utilized as a daily feed or food, administration will be well known to those of ordinary skill.

According to the methods of the invention, administration of the compositions, including administration as part of a dietary regimen, can span a period ranging from parturition through the adult life of the animal. In various embodiments, the animal can be a human or companion animal such as a dog or cat. In certain embodiments, the animal can be a young or growing animal. In more specific embodiments, the animal can be an aging animal. In some embodiments administration begins, for example, on a regular or extended regular basis, when the animal has reached more than about 30%, 40%, or 50% of its projected or anticipated lifespan. In some other embodiments, the animal has attained 40, 45, or 50% of its anticipated lifespan. In vet other embodiments, the animal can be older having reached 60, 66, 70, 75, or 80% of its likely lifespan. A determination of lifespan may be based on actuarial tables, calculations, estimates, or the like, and may consider past, present, and future influences or factors that are known to positively or negatively affect lifespan. Consideration of species, gender, size, genetic factors, environmental factors and stressors, present and past health status, past and present nutritional status, stressors, and the like may also influence or be taken into consideration when determining lifespan.

In a further aspect, the invention provides kits suitable for administering a composition to an animal. The kits can comprise in separate containers in a single package or in separate containers in a virtual package, as appropriate for the kit t one or more semi-moist kibbles, one or more dried meal, and/or one or more dehydrated vegetables and, optionally, one or more of (1) one or more other ingredients suitable for consumption by an animal: (2) one or more B vitamins: (3) one or more antioxidants: (4) one or more prebiotics: (5) one or more probiotics: (6) one or more diagnostic devices suitable for determining whether an animal could benefit from compositions and methods for receiving a health benefit: (7) instructions for how to combine or prepare the semi-moist kibbles, dried meal, and dehydrated vegetables, and any other ingredients provided in the kit for administration to an animal: (8) instructions for how to use the combined kit components, prepared kit components, or other kit components for the benefit of an animal: and (9) a device for administering the combined or prepared kit components to an animal. The components can be each provided in separate containers in a single package or in mixtures of various components in different packages. The kits may comprise the ingredients in various combinations. For example, the kit could comprise a mixture of one or more B vitamins and one or more antioxidants in one container and one or more other ingredients in one or more other containers. Other such combinations can be produced by the skilled artisan based upon the characteristics of the ingredients and their physical and chemical properties and compatibilities.

In another aspect, the invention provides a means for communicating information about or instructions for one or more of (1) using compositions of the present invention: (2) admixing the components of the invention to produce the dehydrated pet food blend: and (3) administering the compositions to an animal. The means comprises one or more of a physical or electronic document, digital storage media, optical storage media, audio presentation, audiovisual display, or visual display containing the information or instructions. In one embodiment, the means can be selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

In another aspect, the present invention provides a package comprising a composition of the present invention and a label affixed to the package containing a word or words, picture, design, acronym, slogan, phrase, or other device, or combination thereof, that indicates that the contents of the package contain a composition suitable for an animal, e.g., a canine. Any package or packaging material suitable for containing the composition can be useful in the invention, e.g., a bag, box, bottle, can, pouch, and the like manufactured from paper, plastic, foil, metal, and the like. In one embodiment, the package contains a food composition adapted for a particular animal such as a canine or feline, as appropriate for the label, and in one aspect, a companion animal food composition.

### EXAMPLES

The invention can be further illustrated by the following example, although it will be understood that this example is included merely for purposes of illustration and is not intended to limit the scope of the invention unless otherwise specifically indicated.

### Example 1—Dehydrated Pet Food Blend for Canines

A dehydrated pet food blend was manufactured by dry mixing semi moist kibbles, dried meal, dehydrated vegetables, vitamins, and minerals. The resulting blend was administered to canines with a 97% acceptance rate.

Additionally, the present blend provides advantages over generally dehydrated foods as the present blend avoid stratification. Also, general dehydrated foods can suffer from mineral/vitamin mix separating from the main food components and concentrating as fines. The present blend did not have such issues.

### Example 2-Dehydrated Pet Food for Canines

A dehydrated pet food was made by dry mixing dehydrated components e.g., meat, vegetables, fruits, fats, vitamins, and minerals. The vegetables and meat were blended following addition of tallow with further blending, followed by addition of powdered ingredients including vitamin and mineral mix with further blending. The resulting composition was less accepted by canines than the dehydrated pet food blend of Example 1.

In the specification, there have been disclosed typical embodiments of the invention. Although specific terms are employed, they are used in a generic and descriptive sense only and not for purposes of limitation. The scope of the invention is set forth in the claims. Obviously, many modifications and variations of the invention are possible in light of the above teachings. It is therefore to be understood that within the scope of the appended claims the invention may be practiced otherwise than as specifically described.

What is claimed is:

1. A dehydrated pet food blend, comprising:
about 15% to about 50% protein;
about 5% to about 40% fat; and
about 5% to about 50% carbohydrate;
wherein the composition comprises semi-moist kibbles, dried meal, and dehydrated vegetables.

2. The dehydrated pet food blend of claim 1, wherein the semi-moist kibbles have a moisture content from about 10% to about 30% by weight.

3. The dehydrated pet food blend of claim 1, wherein the semi-moist kibbles are present in the blend in an amount from about 10% to about 50% by weight.

4. The dehydrated pet food blend of claim 1, wherein the dried meal has a moisture content from about 5% to about 12% by weight.

5. The dehydrated pet food blend of claim 1, wherein the dried meal is present in the blend in an amount from about 40% to about 90% by weight.

6. The dehydrated pet food blend of claim 1, wherein the dehydrated vegetables have a moisture content from about 1% to about 10% by weight.

7. The dehydrated pet food blend of claim 1, wherein the dehydrated vegetables are present in the blend in an amount from about 5% to about 30% by weight.

8. The dehydrated pet food blend of claim 1, further comprising antioxidants, minerals, or vitamins and further comprising a preservative.

9. The dehydrated pet food blend of claim 1, wherein the semi-moist kibbles are coated with an animal digest.

10. The dehydrated pet food blend of claim 1, wherein the blend is formulated as a complete and nutritionally balanced pet food.

11. A method for manufacturing a dehydrated pet food blend, comprising:
extruding a semi-moist kibble;
extruding a dried kibble;
grinding the dried kibble to form a dried meal; and
admixing the semi-moist kibble and the dried meal with dehydrated vegetables to form the dehydrated pet food blend.

12. The method of claim 11, wherein the semi-moist kibbles have a moisture content from about 10% to about 30% by weight and are present in the blend in an amount from about 10% to about 50% by weight.

13. The method of claim 11, wherein the dried meal has a moisture content from about 5% to about 12% by weight and is present in the blend in an amount from about 40% to about 90% by weight.

14. The method of claim 11, wherein the dehydrated vegetables have a moisture content from about 1% to about 10% by weight and are present in the blend in an amount from about 5% to about 30% by weight.

15. The method of claim 11, wherein the method includes drying the extruded dried kibble to remove moisture from the dried kibble, and wherein the dried meal is first admixed with the dehydrated vegetables to form a dried blend, and the dried blend is admixed with the semi-moist kibbles to form the dehydrated pet food blend.
